(19) United States
(12) Patent Application Publication
(10) Pub. No.: US 2023/0405952 A1
(43) Pub. Date: Dec. 21, 2023

(54) MATRIX FOR A TIRE MOLD, MOLD INSERT FOR A TIRE MOLD, TIRE MOLD, AND METHOD FOR PRODUCING A MATRIX FOR A TIRE MOLD

(71) Applicant: HERBERT Tire Tooling GmbH & Co. KG, Huenfeld (DE)

(72) Inventors: Sebastian Popp, Petersberg (DE); Wolfgang Voegler, Eiterfeld (DE)

(21) Appl. No.: 18/206,693

(22) Filed: Jun. 7, 2023

(30) Foreign Application Priority Data
Jun. 8, 2022 (DE) 10 2022 114 361.9

(51) Int. Cl. B29D 30/06; B29C 33/38

(52) U.S. Cl. CPC B29D 30/0606; B29D 2030/0613; B29C 33/3842

(57) ABSTRACT

The invention relates to a matrix for a tire mold for vulcanizing tire blanks, the matrix forming a negative mold of a profiled tread of a tire, the matrix having a mold shell and at least one fin plate disposed thereon, the mold shell forming a mold inside and the fin plate forming a web of the negative mold, a slit being formed in the mold shell, the fin plate being inserted into the slit and attached to the mold shell. The slit penetrates a mold wall of the mold shell and extends from the mold inside to a mold back side of the mold shell, the fin plate being bonded to the mold shell from the mold back side.

### CROSS-REFERENCE TO RELATED APPLICATIONS

This application claims the benefit of German Patent Application 10 2022 114 361.9, filed Jun. 8, 2022, the content of which is incorporated herein by reference for all purposes in its entirety.

The disclosure relates to a matrix for a tire mold for vulcanizing tire blanks, a mold insert for a tire mold for vulcanizing tire blanks, a tire mold for vulcanizing tire blanks, and a method for producing a matrix for a tire mold for vulcanizing tire blanks, the matrix forming a negative mold of a profiled tread of a tire, the matrix having a mold shell and at least one fin plate disposed thereon, the mold shell forming a mold inside and the fin plate forming a web of the negative mold, a slit being formed in the mold shell, the fin plate being inserted into the slit and attached to the mold shell.

Matrices of this kind are sufficiently known from the state of the art and serve to line a tire mold used for vulcanizing tire blanks. In order to form a profiled tread of a tire, in particular fine profile grooves of the tread, thin fin plates are attached to a mold shell of the matrix. The fin plates each form a web of the negative mold on a mold inside of the mold shell. Since the fin plates are at least thinner than 0.5 mm, they can hardly be produced cost-efficiently by machining the mold shell. Hence, it is also known for a plurality of slits to be formed in the mold shell, in each of which the fin plates are fastened. The fin plates are typically fastened in the respective slits by means of an adhesive material or by welding them to the material of the mold shell from the mold inside, a weld or an adhesive seam being formed in the slit on the mold inside. The essential aspect is that a fin plate cannot leave the slit when a vulcanized tire is removed from the tire mold. In vulcanization, a tire blank is placed in the tire mold, the material of the tread being plasticized as a result of temperature effects until the fin plates can penetrate the material of the tread in such a manner that the negative mold or the mold inside is fully filled or covered by the material of the tread. Since air is trapped in spaces between fin plates or profile grooves of the negative mold, the tire mold typically has to be deaerated during vulcanization. For this purpose, relatively thin bores, through which air can escape, are formed in the tire mold or the mold inside. Part of the material of the tread enters these bores during vulcanization with the result that filament-like material residue from these bores may be visible on the tread of a finished and molded tire.

The known matrices are disadvantageous in that welding or gluing the fin plates to the mold shell from the mold inside is very difficult or often even impossible because of confined space conditions when producing a matrix with relatively tightly packed fin plates, i.e., relatively narrow spaces between the fin plates. Moreover, the adhesive seams or welds formed between the fin plates and the mold shell or the mold inside during gluing and welding often leave traces in the form of imprints or the like on a tire produced using such a matrix, in particular on a treat of the tire, which are undesired by the customer.

Furthermore, a generic matrix for a tire mold for vulcanizing tire blanks is known from DE 10 2016 204 416 A1, wherein fin plates of the matrix are attached to a mold shell of the matrix in a form-fitting manner. For attaching the fin plates to the mold shell in a form-fitting manner, the fin plates each form a tab, which is formed by one or more separating slits and which can be bent out of a slit plane after the fin plates have been inserted into slits formed in the mold shell. After bending, the tabs are in particular in contact with a mold back side of the mold shell with the result that the fin plates can no longer be pulled out of the slits and are clamped between a mold inside of the mold shell and the mold back side without play.

However, such a matrix is disadvantageous in that such a form-fitting connection is typically not strong enough with the result that the fin plates can leave the slits, in particular when a vulcanized tire is removed form a tire mold comprising such a matrix. Consequently, fin plates that have left the slits, in particular after a tire has been removed from the tire mold, often have to be attached to the mold shell again, which is laborious. Also, a tab can be damaged by a removal of a fin plate from a slit with the result that the fin plate may even have to be replaced.

Hence, the object of the present disclosure is to propose a matrix for a tire mold, a mold insert for a tire mold, a tire mold, and a method for producing a matrix for a tire mold that enable a production of a tire optimized with regard to the disadvantages described above, in particular a more cost-efficient production.

This object is attained by a matrix for a tire mold having the features of claim 1, a mold insert having the features of claim 12, a tire mold having the features of claim 14, and a method for producing a matrix for a tire mold having the features of claim 15.

The matrix according to the disclosure for a tire mold for vulcanizing tire blanks forms a negative mold of a profiled tread of a tire, the matrix having a mold shell and at least one fin plate disposed thereon, the mold shell forming a mold inside and the fin plate forming a web of the negative mold, a slit being formed in the mold shell, the fin plate being inserted into the slit and attached to the mold shell, wherein the slit penetrates a mold wall of the mold shell and extends from the mold inside to a mold back side of the mold shell, the fin plate being bonded to the mold shell from the mold back side.

According to the disclosure, the fin plate is inserted into the slit, the slit in the mold shell preferably extending orthogonally in the mold wall; i.e., the slit penetrates the mold wall in a radial direction. The matrix can preferably have a plurality of fin plates, each of which can be inserted into an associated slit in the mold shell. A height of the fin plate is configured in such a manner that the fin plate forms a web, which can form a fin in the tread of the tire, on the mold inside and is inserted into the slit far enough for a bonded connection of the fin plate to the mold shell or in the slit from the mold back side is possible. Preferably, the fin plate can be welded to the mold shell. Alternatively, the fin plate can be glued or soldered to the mold shell. A filler material used for forming the bonded connection can partially enter the slit from the mold back side and bond the fin plate to the mold shell. Since the fin plate is bonded to the mold shell from the mold back side, a weld or an adhesive seam is formed in the slit on the mold back side only. In other words, the mold inside is completely free from welds or adhesive seams of this kind with the result that no undesired traces or imprints in a tread of the tire are present in a tire produced using the matrix according to the disclosure. Moreover, the bonded connection can be formed with a relatively high connection strength with the result that a removal of the fin plate from the slit, in particular when removing a vulcanized tire from a tire mold comprising the matrix according to the disclosure, can be reliably avoided. Moreover, the fact that the fin plate is attached to the mold shell from the mold back side allows the matrix to be formed with relatively closely packed fin plates, in principle, since space conditions on the mold back side are significantly less confined than on the mold inside. Moreover, this fact makes replacing the fin plate in the event of damage simpler, in particular since severing the weld or the adhesive seam and potential post-processing of the slit on the mold back side cannot adversely affect the mold inside. Furthermore, a tire mold comprising the matrix according to the disclosure can be deaerated through the slit penetrating the mold wall, in which case the slit may be filled and sealed, in particular with filler material used for the bonded connection, only to the extent that gaps remain present in the slit between the fin plate and the mold shell through which air can escape to deaerate the tire mold. In this case, no bores for deaerating the mold shell have to be formed, which makes the tire mold and the matrix even more cost-efficient to produce. Also, the filament-shaped material residue common otherwise on the tread of the tire do not occur. As a result, tires can be produced in a manner optimized with regard to the disadvantages known from the state of the art, in particular more cost-efficiently, by means of the matrix according to the disclosure.

Advantageously, the slit can have a first portion, which extends from the mold inside, and a second portion, which extends from the mold back side and ends in the first portion. The fin plate can be inserted into the slit in such a manner, preferably from the mold inside, that it can penetrate the first portion and protrude out of the first portion into the second portion and at least partially extend along a depth direction of the slit in the second portion. Preferably, the first portion can be formed from the mold inside and the second portion can be formed from the mold back side. The first portion can be formed before the second portion or after the second portion. Advantageously, the first portion can be formed before the second portion. It is also possible for both portions to be formed from the mold inside or the mold back side. For forming the slit, the first portion can advantageously be formed first from the mold inside, the second portion being formed from the mold back side afterward with such a depth that the second portion meets, i.e., ends in, the first portion. The first portion can be formed with a first depth and the second portion can be formed with a second depth; a sum of the first depth and the second depth can be equal to a distance between the mold inside and the mold back side. Furthermore, the slit in the first portion can be produced with a different method than the slit in the second portion. Nevertheless, the entire slit can be produced in one piece from the mold inside or from the mold back side only.

Advantageously, a depth of the first portion, i.e., the first depth, can be 2 mm to 10 mm, and/or a depth of the second portion, i.e., the second depth, can be 8 mm to 28 mm. This depth is sufficient for safely fastening the fin plate in the slit or on the mold shell.

In an embodiment of the disclosure, a shape of the slit in the first portion and/or a shape of the slit in the second portion can follow a cross-sectional shape of the fin plate. In other words, a shape of the slit can correspond to a cross-sectional shape of the fin plate. For example, the slit can have a round-arch-shaped or undulating shape if the cross section of the fin plate is round-arch-shaped or undulating. The fact that the shape of the slit can follow the cross-sectional shape of the fin plate makes it possible for an additional form fit to be established between the fin plate and the mold shell, which can advantageously increase the strength of the connection. Moreover, if the shape of the slit follows the cross-sectional shape of the fin plate at least in the first portion, almost no material of the tread can enter the slit during vulcanization with the result that material residue on the tread can be reduced. Advantageously, the shape of the slit can follow the cross-sectional shape of the fin plate in the first portion only, in which case the slit in the second portion can have any shape without particular regard to the cross-sectional shape of the fin plate. For example, the slit in the second portion can be a simple cutout or an oblong hole, which can be produced in relatively little time. In this case, the slit can be formed by first forming the first portion with a shape following the cross-sectional shape of the fin plate from the mold inside, the second portion being formed afterward from the mold back side in the shape of the cutout or the oblong hole, e.g., by milling, with such a depth that the second portion meets, i.e., ends in, the first portion.

So the slit in the second portion can advantageously be an oblong hole.

In a constructively advantageous embodiment of the disclosure, a length of the fin plate, with respect to a longitudinal dimension of the fin plate, can be partially greater than a length of the slit in the first portion and/or a length of the slit in the second portion. In this case, ends of the fin plate can form a stop or a protrusion, which can be in contact with the mold inside, for example, if the length of the fin plate is partially greater than the length of the slit in the first portion. Furthermore, a length of the slit in the first portion can be greater than a length of the slit in the second portion. In this case, the length of the fin plate can be partially greater than the length of the slit in the second portion. As a result, the stop or protrusion of the fin plate or another stop or another protrusion of the fin plate can be in contact with a shoulder formed in the slit between the first portion and the second portion. An extension of the fin plate can protrude into or be disposed in the second portion. This can advantageously support a reliable fastening of the fin plate in the slit and ensure a required dimension of the fin plate along its height in order to form the web on the mold inside. Furthermore, a length of the fin plate, in particular in a central portion of the fin plate located above the stop or protrusion, can be dimensioned in such a manner that the fin plate can essentially extend across an entire length of the mold shell or between profile groove webs of the mold shell.

So a length of the slit in the first portion can advantageously be greater than a length of the slit in the second portion. Nevertheless, the length of the slit in the first portion can also be equal to the length of the slit in the second portion.

Advantageously, a distance between the mold inside and the mold back side can be 10 mm to 30 mm.

Furthermore, a distance between each two adjacent fin plates can be 1 mm to 10 mm, 1 mm to 5 mm or 1 mm to 3 mm if the matrix has a plurality of fin plates. A distance between a fin plate and an adjacent profile groove web of the mold shell running parallel to the fin plate can advantageously also have these dimensions.

In an embodiment of the disclosure, the slit can be formed by milling and/or spark erosion. In particular, the first portion and/or the second portion can be formed by milling and/or spark erosion.

Advantageously, the fin plate can at least partially have a round-archshaped or undulating cross section, in particular within the slit. It is also possible for the entire fin plate to have the round-arch-shaped or undulating cross section. The round-arch-shaped or undulating design of the cross section of the fin plate within the slit allows the fin plate to be clamped into the slit in the manner of a leaf spring depending on the design of the slit. This leads to a form fit which can advantageously increase the strength of the connection. Moreover, depending on the design of the slit, the formation of gaps which can be used for deaerating the tire mold can be ensured.

Furthermore, the fin plate can be at least partially in contact with the mold inside and/or with a shoulder formed in the slit, i.e., between the first portion and the second portion. For example, the fin plate can be in contact with the mold inside at its outer ends with respect to its longitudinal dimension. This ensures that the fin plate is positioned in the desired position on the mold shell relative to the mold inside. In this case, the fin plate forms the web of the negative mold with a defined height and cannot slide further into the slit. Alternatively or additionally, the fin plate can at least partially be in contact with the shoulder formed in the slit between the first portion and the second portion, which has similar advantages.

Furthermore, a slit width of the slit and a plate thickness of the fin plate can be dimensioned in such a manner that a gap channel and the gaps between the fin plate and the slit and the mold shell can be formed, respectively. In this case, the tire mold can be deaerated through the gap channel. A width of the gap channel can be particularly thin since a particularly large cross section of the gap channel for deaeration can still be formed across a length of the gap channel along the slit. If the gap channel is particularly thin, hardly any material of the tread enters the gap channel during vulcanization, which is why material residue on the tread can be reduced significantly.

The gap channel can be 0.01 mm to 0.1 mm, preferably 0.03 mm to 0.04 mm, wide. A gap channel of this width is sufficient for ensuring adequate deaeration of the tire profile or a profile portion between two fin plates during the vulcanization of a tire blank.

Hence, the gap channel can also be a deaeration channel for deaerating the tire mold. Excess air can be discharged from the tire mold through other channels on the mold back side of the mold shell, if applicable.

Advantageously, the fin plate is disposed in the slit in such a manner that it does not protrude from the slit on the mold back side. On the mold back side, the fin plate can be flush with the mold back side. Alternatively, the fin plate can be recessed in the slit with respect to the mold back side. In both cases, the matrix becomes easier to handle since the fin plate cannot be damaged from the mold back side and does not protrude in a hindering manner when installing the matrix, in particular on a support of a mold insert.

Furthermore, the matrix can be composed of a plurality of mold shells. In this case, the matrix is more cost-efficient to produce since smaller portions of the matrix can be processed, in particular in the case of complex profiles of the tread. Potential mistakes during the processing of the matrix or the mold shell thus cause lower reject costs.

The mold insert according to the disclosure for a tire mold for vulcanizing tire blanks comprises at least one matrix according to the disclosure.

In an advantageous variation of the disclosure, the mold insert can have a support which supports or carries the matrix and which can be connected, preferably screwed, to the matrix in a detachable manner and which can be disposed on the mold back side. Consequently, the mold insert can be composed of two parts and comprise the matrix, which forms a mold part, and the support, which forms a back part, as components. In this case, the support can form a back of the mold insert. Advantageously, the support can cover the slit on the mold back side, whereby the points of connection, i.e., the connecting seams, can be protected from external conditions and effects. The matrix can be disposed on an upper side of the support in such a manner that the mold back side can come into contact with the upper side. The matrix can be screwed to the support, e.g., by means of two screw means, from the underside of the support, for which purpose bores can be provided in the support and/or the matrix. Furthermore, the upper side can form a depression into which the matrix can be inserted. The detachable connection and the two-piece configuration also enable in particular a separate replacement of the matrix or the support. Furthermore, the matrix can be composed of a plurality of mold shells each having fin plates, which can be connected or screwed to the support in a detachable manner together. Also, multiple matrices can be disposed on the support. Furthermore, the provision of the detachable support makes it possible for the slit to be relatively short since it is formed in the mold shell or the matrix only. A height of the matrix and of the support can be dimensioned in such a manner that a sum of their heights is equal to a height of a conventional single-piece mold insert. Furthermore, bores for deaerating the tire mold, which can end in the slit, can be provided in the support. So the mold insert is advantageously composed of two parts. Nevertheless, the mold insert can also be a single part. In this case, the mold back side of the mold shell can form a back or at least part of a back of the mold insert.

The tire mold according to the disclosure for vulcanizing tire blanks has a plurality of tire mold segments, the tire mold segments each being composed of a segment base and a mold insert according to the disclosure. Thus, large tire mold segments can be produced simply by attaching a plurality of mold inserts to the segment base. Each mold insert can have at least one or more than one matrix.

In the method according to the disclosure for producing a matrix for a tire mold for vulcanizing tire blanks, the matrix forms a negative mold of a profiled tread of a tire, at least one fin plate of the matrix being arranged on a mold shell of the matrix, the mold shell forming a mold inside and the fin plate forming a web of the negative mold, a slit being formed in the mold shell, the fin plate being inserted into the slit and attached to the mold shell, wherein the slit is formed in such a manner that it penetrates a mold wall of the mold shell and extends from the mold inside to a mold back side of the mold shell, the fin plate being bonded to the mold shell from the mold back side. Regarding the advantageous effects of the method according to the disclosure, reference is made to the description of advantages of the matrix according to the disclosure.

Advantageously, the fin plate can be inserted into the slit from the mold inside.

Advantageously, a first portion of the slit can be formed from the mold inside and a second portion of the slit, which ends in the first portion, can be formed from the mold back side.

Advantageously, the fin plate can be welded to the mold shell, in which case a weld can be formed in the slit or in the second portion on the mold back side.

Other advantageous embodiments of the method are apparent from the description of features of the dependent claims referring to device claim 1.

Hereinafter, preferred embodiments of the disclosure will be discussed in more detail with reference to the accompanying drawings.

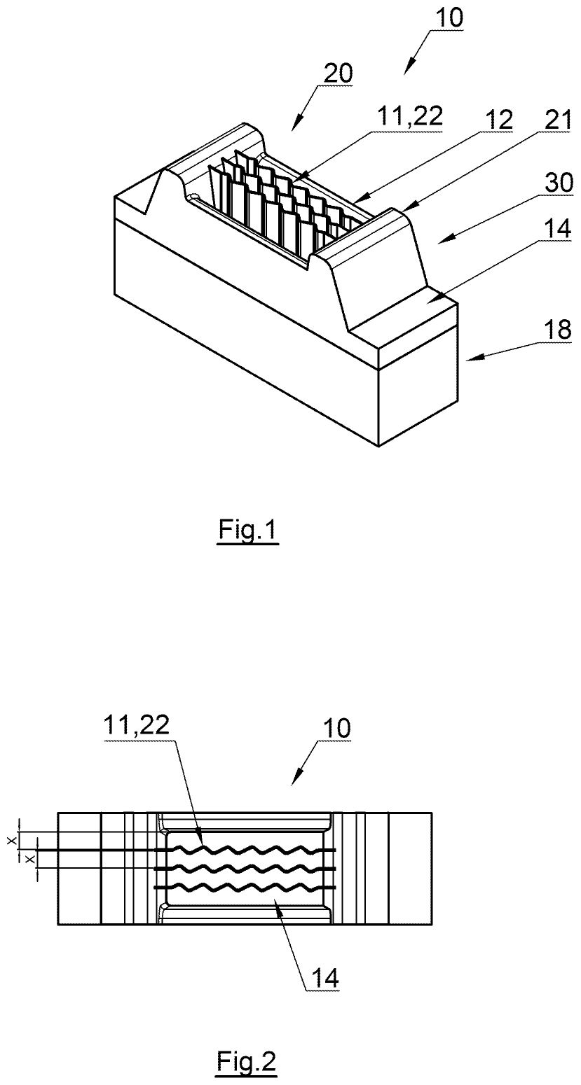

FIG. 1 is a perspective view of a mold insert;

FIG. 2 is a top view of the mold insert;

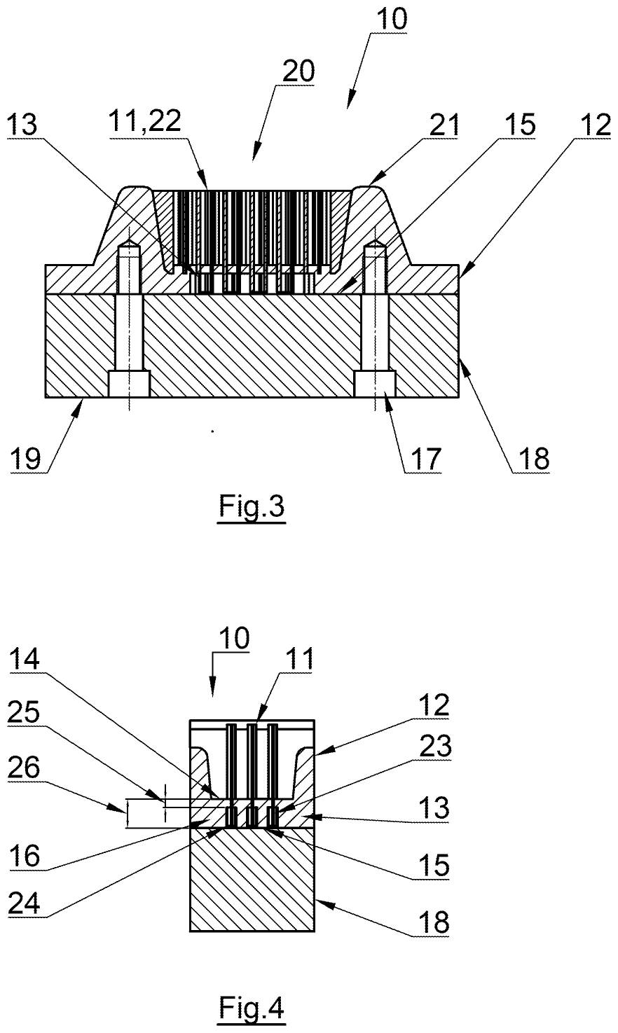

FIG. 3 is a sectional view of the mold insert along an axis A-A shown in FIG. 2;

FIG. 4 is a sectional view of the mold insert along an axis B-B shown in FIG. 2;

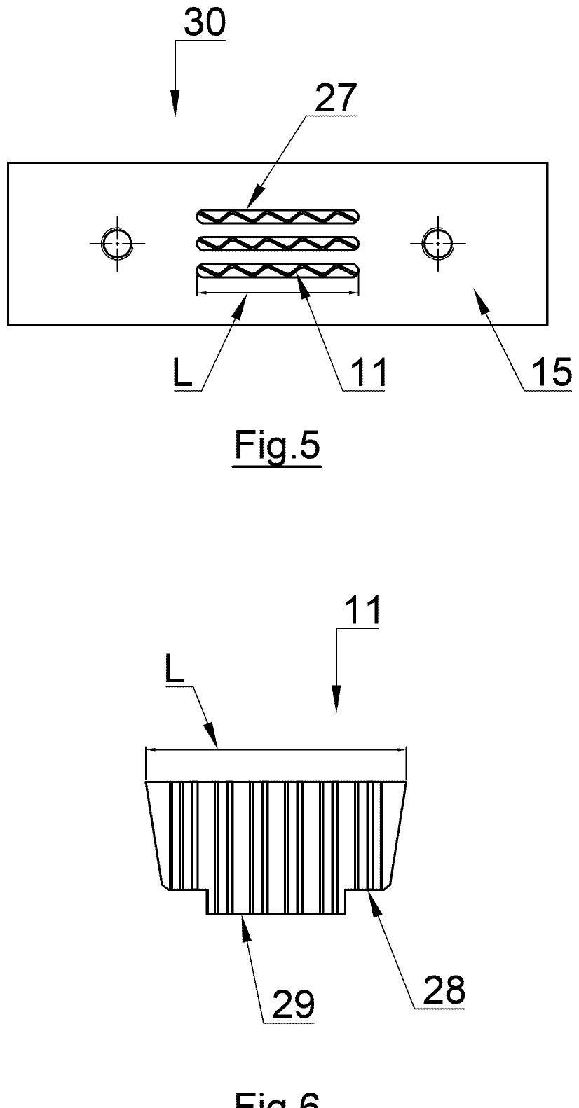

FIG. 5 is a bottom view of a matrix of the mold insert;

FIG. 6 is a side view of a fin plate of the matrix;

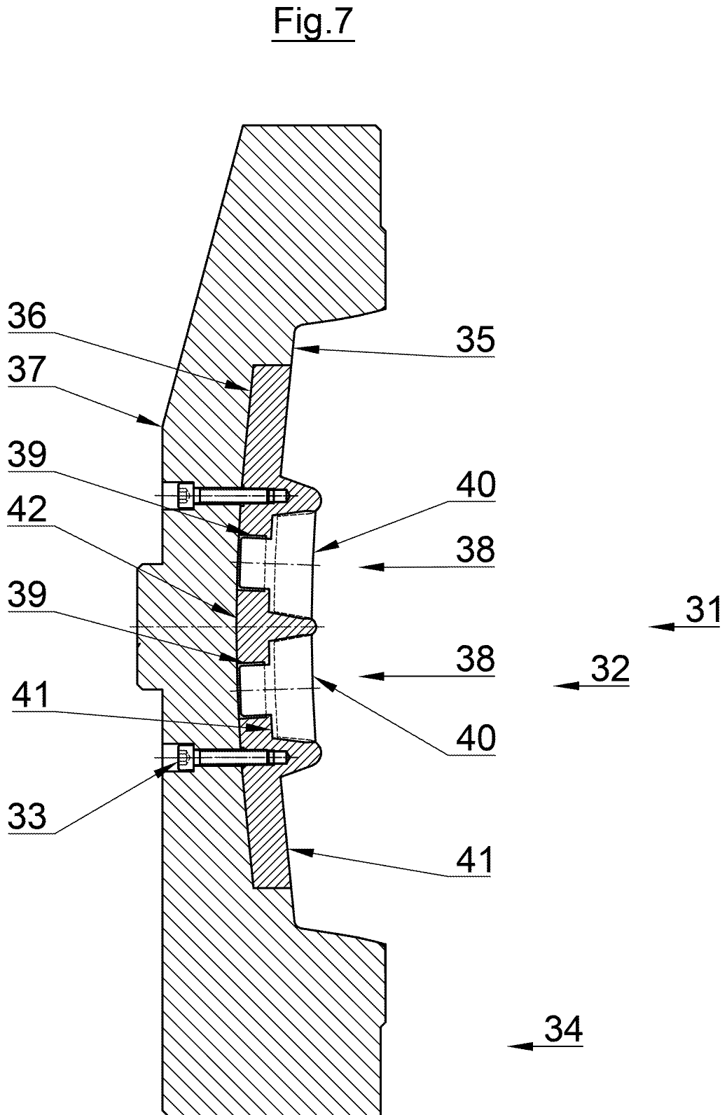

FIG. 7 is a sectional view of a mold insert in another embodiment.

A combination of FIGS. 1 to 5 shows a mold insert 10, which comprises a matrix 30, which has a plurality of fin plates 11 (three in the case at hand), which are each disposed in slits 13, which are formed in a mold shell 12 of matrix 30. Slits 13 extend in mold shell 12 in such a manner that they penetrate a mold wall 16 of mold shell 12 from a mold inside 14 of mold shell 12 to a mold back side 15 of mold shell 12. Furthermore, mold insert 10 comprises a support 18, which is connected to matrix 30 in a detachable manner by means of screw means 17 and which is disposed on mold back side 15 and forms a back of mold insert 10. Screw means 17 engage mold insert 10 from an underside 19 of support 18. Furthermore, mold inside 14 forms a negative mold 20 for a tire blank (not shown) to be vulcanized, profile groove webs 21 being formed on mold inside 14. Fin plates 11 each also form a web 22 of negative mold 20.

Slits 13 each form a first portion 23, which is formed from mold inside 14, and a second portion 24, which is formed from mold back side 15, second portion 24 ending in first portion 23. First portion 23 has a depth 25, a depth of second portion 24 being defined by a distance 26 between mold inside 14 and mold back side 15 minus depth 25. A shape of slits 13 in first portion 23 follows a round-archshaped or undulating cross section of fin plates 11, whereas slits 13 in second portion 24 each form an oblong hole 27. This makes it possible to reduce a production time of slits 13. Furthermore, fin plates 11 are welded to mold shell 13 in slit 13 or in second portion 24 from mold back side 15, a weld (not shown) being formed in slit 13 or in second portion 24 on mold back side 15. Since fin plates 11 are welded to mold shell 12 from mold back side 15, mold inside 14 is completely free from welds. Furthermore, welding from mold back side 15 makes it possible for matrix 10 to be formed with relatively narrow spaces x, in particular between fin plates 11.

FIG. 6 shows a fin plate 11, an upper length L of fin plate 11 being greater than a length 1 of slits 13 in second portion 24, i.e., oblong holes 27. Furthermore, fin plate 11 forms a protrusion 28, which can be in contact with a shoulder (not shown) formed in each slit 13 between first portion 23 and second portion 24, and an extension 29 of fin plate 11 can protrude into second portion 24. A length (not shown) of slits 13 in first portion 23 is greater than length l.

FIG. 7 shows a mold insert 31, which comprises a matrix 32 and a support 34, which is connected to matrix 32 in a detachable manner by screw means 33 and which forms a back of mold insert 31, support 34 forming a depression 34, into which matrix 32 is inserted, on an upper side 35 of support 34. Screw means 33 engage mold insert 31 from an underside 37 of support 34. Furthermore, matrix 32 comprises two mold shells 38 in the case at hand, which each have fin plates 40, which are each inserted into slits 39, which are formed in each mold shell 38. Slits 39 each extend from a mold inside 41 of mold shells 38 to a mold back side 42 of mold shells 38. Furthermore, fin plates 40 are each welded to mold shells 38 from mold back side 42. Otherwise, mold insert 31 can be configured in the same manner as mold insert 10, which is why reference is additionally made to the explanations made with regard to FIGS. 1 to 6.

1. A matrix for a tire mold for vulcanizing tire blanks, the matrix forming a negative mold of a profiled tread of a tire, the matrix having a mold shell and at least one fin plate disposed thereon, the mold shell forming a mold inside and the fin plate forming a web of the negative mold, a slit being formed in the mold shell, the fin plate being inserted into the slit and attached to the mold shell,
wherein
the slit penetrates a mold wall of the mold shell and extends form the mold inside to a mold back side of the mold shell, the fin plate being bonded to the mold shell from the mold back side.

2. The matrix according to claim 1,
wherein
the slit has a first portion which extends from the mold inside and a second portion, which extends from the mold back side and ends in the first portion.

3. The matrix according to claim 2,
wherein
a depth of the first portion is 2 mm to 10 mm and/or a depth of the second portion is 8 mm to 28 mm.

4. The matrix according to claim 2,
wherein
a shape of the slit in the first portion and/or a shape of the slit in the second portion follows a cross-sectional shape of the fin plate.

5. The matrix according to claim 2,
wherein
the slit is an oblong hole in the second portion.

6. The matrix according to claim 2,
wherein
a length of the fin plate is partially greater than a length of the slit in the first portion and/or a length of the slit in the second portion.

7. The matrix according to claim 2,
wherein
a length of the slit in the first portion is greater than a length of the slit in the second portion.

8. The matrix according to claim 1,
wherein
a distance between the mold inside and the mold back side is 10 mm to 30 mm.

9. The matrix according to claim 1,
wherein
the slit is formed by milling and/or spark erosion.

10. The matrix according to claim 1,
wherein
the fin plate at least partially has a round-arch-shaped or undulating cross section, in particular within the slit.

11. The matrix according to claim 1,
wherein
the fin plate is at least partially in contact with the mold inside and/or a shoulder formed in the slit.

12. A mold insert for a tire mold for vulcanizing tire blanks, wherein the mold insert comprises at least one matrix according to claim 1.

13. The mold insert according to claim 12,
wherein
the mold insert comprises a support configured to be connected, preferably screwed, to the matrix in a detachable manner and to be disposed on the mold back side.

14. A tire mold for vulcanizing tire blanks, wherein the tire mold has a plurality of tire mold segments, the tire mold segments each being composed of a segment base and a mold insert according to claim 12.

15. A method for producing a matrix for a tire mold for vulcanizing tire blanks, the matrix forming a negative mold of a profiled tread of a tire, at least one fin plate of the matrix being arranged on a mold shell of the matrix, the mold shell forming a mold inside and the fin plate forming a web of the negative mold, a slit being formed in the mold shell, the fin plate being inserted into the slit and attached to the mold shell,
wherein
the slit is formed in such a manner that it penetrates a mold wall of the mold shell and extends from the mold inside to a mold back side of the mold shell, the fin plate being bonded to the mold shell from the mold back side.

16. The method according to claim 15,
wherein
the fin plate is inserted into the slit from the mold inside.

17. The method according to claim 15,
wherein
a first portion of the slit is formed from the mold inside and a second portion of the slit, which ends in the first portion, is formed from the mold back side.

18. The method according to claim 15,
wherein
the fin plate is welded to the mold shell, a weld being formed in the slit on the mold back side.
